(19) United States
(12) Patent Application Publication
(10) Pub. No.: US 2023/0273384 A1
(43) Pub. Date: Aug. 31, 2023

(54) OPTICAL CABLE REINFORCEMENT WITH LOW ACIDITY

(71) Applicant: CORNING RESEARCH & DEVELOPMENT CORPORATION, Corning, NY (US)

(72) Inventors: Sergey Vladimirovich Chernykh, Hickory, NC (US); Tomasz Kazmierczak, Lodz (PL); Martina Petra Richter-Bühling, Neustadt bei Coburg (DE)

(21) Appl. No.: 18/144,326

(22) Filed: May 8, 2023

Related U.S. Application Data
(63) Continuation of application No. PCT/US2021/058713, filed on Nov. 10, 2021.
(60) Provisional application No. 63/116,235, filed on Nov. 20, 2020.

(51) Int. Cl. G02B 6/44; D01H 13/04

(52) U.S. Cl. CPC G02B 6/4432; D01H 13/04; G02B 6/4434; G02B 6/4436; D10B 2321/0211

(57) ABSTRACT

Embodiments of the disclosure relate to an optical fiber cable. The optical fiber cable includes a cable jacket having an interior surface and an exterior surface. The interior surface defines a central bore extending along a longitudinal axis of the optical fiber cable, and the exterior surface defines an outermost surface of the optical fiber cable. At least one subunit is disposed within the central bore. Each of the at least one subunit includes at least one optical fiber disposed within a buffer tube. A plurality of ultrahigh molecular weight polyethylene (UHMWPE) tensile yarns are positioned around the at least one subunit and extend along the longitudinal axis. A layer of a bedding compound is disposed between the plurality of UHMWPE tensile yarns and the cable jacket.

### CROSS-REFERENCE TO RELATED APPLICATION

This application is a continuation of International Application No. PCT/US2021/058713 filed Nov. 10, 2021, which claims the benefit of priority under 35 U.S.C. § 119 of U.S. Provisional Application Serial No. 63/116,235, filed on Nov. 20, 2020, the content of which is relied upon and incorporated herein by reference in its entirety.

### BACKGROUND

The disclosure relates generally to optical fiber cables, and specifically to optical fiber cables having tensile elements that do not include aramid fibers. Optical fiber cables may be routed to and throughout a premise. As with other building materials contained within the premises, the optical fiber cables may be designed or be mandated to comply with certain flame retardancy standards. These design aspects may dictate the use of certain materials in the construction of the optical fiber cable. Additional design pressure may arise from the marketplace in terms of cost or scarcity of materials.

### SUMMARY

According to an aspect, embodiments of the disclosure relate to an optical fiber cable. The optical fiber cable includes a cable jacket having an interior surface and an exterior surface. The interior surface defines a central bore extending along a longitudinal axis of the optical fiber cable, and the exterior surface defines an outermost surface of the optical fiber cable. At least one subunit is disposed within the central bore. Each of the at least one subunit includes at least one optical fiber disposed within a buffer tube. A plurality of ultrahigh molecular weight polyethylene (UHMWPE) tensile yarns are positioned around the at least one subunit and extend along the longitudinal axis. A layer of a bedding compound is disposed between the plurality of UHMWPE tensile yarns and the cable jacket.

According to another aspect, embodiments of the disclosure relate to an optical fiber cable. The optical fiber cable includes a cable jacket having an interior surface and an exterior surface. The interior surface defines a central bore extending along a longitudinal axis of the optical fiber cable, and the exterior surface defines an outermost surface of the optical fiber cable. At least one subunit is disposed within the central bore. Each of the at least one subunit includes at least one optical fiber disposed within a buffer tube. A plurality of tensile yarns is disposed within the central bore around the at least one subunit and extends along the longitudinal axis. The plurality of tensile yarns are basalt yarns.

According to a further aspect, embodiments of the disclosure relate to a method of manufacturing an optical fiber cable. In the method, a plurality of tensile yarns is arranged around at least one subunit. Each of the at least one subunit has at least one optical fiber disposed within a buffer tube. The plurality of tensile yarns are at least one of ultra-high molecular weight polyethylene (UHMWPE) yarns or basalt yarns. In the method, a cable jacket is extruded around the plurality of tensile yarns. The cable jacket has an interior surface and an exterior surface. The exterior surface is an outermost surface of the optical fiber cable, and the interior surface is arranged facing the plurality of tensile yarns.

According to a further aspect, embodiments of the disclosure relate to an optical fiber cable. The optical fiber cable includes a cable jacket having an interior surface and an exterior surface. The interior surface defines a central bore extending along a longitudinal axis of the optical fiber cable, and the exterior surface defines an outermost surface of the optical fiber cable. At least one subunit is disposed within the central bore. Each of the at least one subunit includes at least one optical fiber disposed within a buffer tube. A plurality of tensile yarns is disposed within the central bore and around the at least one subunit. The plurality of tensile yarns extends along the longitudinal axis. Further, the plurality of tensile yarns produce combustion gasses having a conductivity of 0.50 µS/mm or less and a pH of 5.0 or greater in aqueous solution according to EN 50267-2-3.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a cross-sectional view of an optical fiber cable comprising a plurality of subunits, tensile yarns arranged around the subunits, and a layer of a bedding compound around the tensile yarns, according to an exemplary embodiment;

FIG. 2 depicts a cross-sectional view of an optical fiber cable comprising a single subunit and tensile yarns arranged around the subunit, according to an exemplary embodiment;

FIG. 3 depicts a cross-sectional view of an optical fiber cable comprising a single subunit, tensile yarns arranged around the subunit, and a layer of a bedding compound around the tensile yarns, according to an exemplary embodiment;

FIG. 4 depicts a cross-sectional view of an optical fiber cable comprising a single subunit, tensile yarns arranged around the subunit, and a layer of a bedding compound having additional tensile yarns embedded therein, according to an exemplary embodiment;

FIG. 5 depicts a cross-sectional view of an optical fiber cable comprising a plurality of subunits, tensile yarns arranged around the subunits, and a layer of water-blocking provided around the tensile yarns, according to an exemplary embodiment;

FIG. 6 depicts a cross-sectional view of an optical fiber cable comprising a single subunit having a plurality of optical fibers and tensile yarns arranged around the subunit, according to an exemplary embodiment;

FIG. 7 depicts a cross-sectional view of an optical fiber cable comprising a single subunit having a plurality of optical fibers, a plurality of tensile yarns arranged around the subunit, and a layer of bedding compound provided around the tensile yarns, according to an exemplary embodiment; and

FIG. 8 depicts a cross-sectional view of an optical fiber cable comprising a plurality of subunits surrounded by a cable jacket and tensile yarns disposed in the cable jacket, according to an exemplary embodiment.

### DETAILED DESCRIPTION

Referring generally to the figures, various embodiments of an optical fiber cable having low acid gases evolved during combustion are provided. The optical fiber cable includes tensile elements made from ultra-high molecular weight polyethylene (UHMWPE) and/or basalt yarns. As compared to conventional tensile elements made from aramid yarns, the yarns of the tensile elements included in the presently disclosed optical fiber cables produce gasses during combustion that have a lower conductivity, allowing the optical fiber cable to achieve an a1 rating according to EN 50267-2-3. Advantageously, the UHMWPE and basalt yarns provide enhanced mechanical properties and are relatively less expensive than aramid yarns. Further, despite the relatively lower operational temperature of UHMWPE yarns, embodiments of the optical fiber cables include a layer of a bedding compound that allows for the cable jacket of the optical fiber cable to be extruded around the UHMWPE yarns without degrading the mechanical properties of the UHMWPE yarns. Each of these exemplary embodiments will be described in greater detail below, and these exemplary embodiments are provided by way of illustration, and not by way of limitation. These and other aspects and advantages will be discussed in relation to the embodiments provided herein.

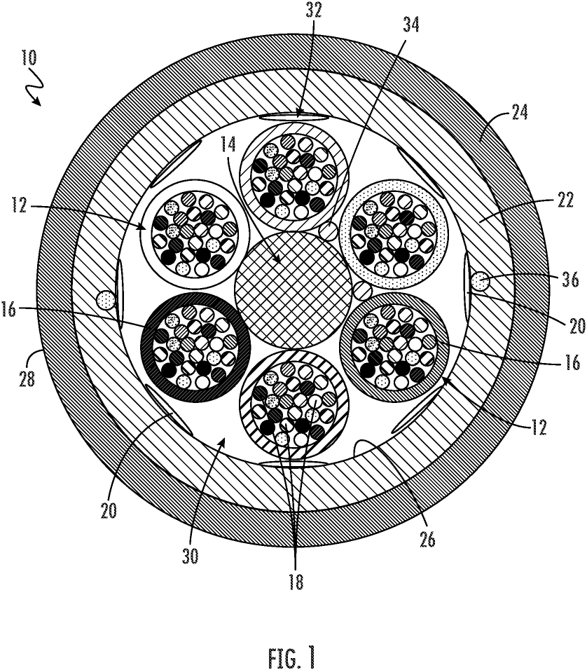

FIG. 1 depicts an embodiment of an optical fiber cable 10. The optical fiber cable 10 includes a plurality of subunits 12 stranded around a central strength member 14. In the embodiment depicted, each subunit 12 includes a buffer tube 16 defining a central bore in which a plurality of optical fibers 18 are disposed. In particular, the optical fiber cable 10 depicts the optical fibers 18 arranged in the buffer tubes 16 in a loose tube configuration. However, in other embodiments, one or more of the subunits 12 could include optical fibers 18 arranged in one or more stacks of ribbons, or each subunit 12 may comprise a single optical fiber 18 with a tight buffer tube 16. Further, in embodiments, one or more subunits 12 may comprise a high-density ribbon bundle (such as included in a Rocket Ribbon™ Extreme Density Cable, available from Corning Incorporated, Corning, NY).

A plurality of tensile yarns 20 are arranged around the subunits 12. As will be discussed more fully below, the tensile yarns 20 are comprised of yarns of at least one of ultra-high molecular weight polyethylene (UHMWPE) or basalt. These yarns produce gasses during combustion that exhibit reduced conductivity in an aqueous solution as compared to conventionally used aramid yarns. Further, the mechanical properties of tensile yarns 20 made of UHMWPE or basalt are not substantially reduced and are, in some cases, improved over the mechanical properties of conventional aramid tensile yarns. In the embodiment depicted in FIG. 1, eight tensile yarns 20 are provided around the subunits 12. In other embodiments, the number of tensile yarns 20 is from two to thirty-six. Further, in embodiments, the tensile yarns 20 may be wrapped around the subunits 12, e.g., in a helically manner, or in other embodiments, the tensile yarns 20 may extend along the length of the optical fiber cable 10 parallel to the longitudinal axis of the optical fiber cable 10.

In embodiments, the tensile yarns 20 are surrounded by a layer of a bedding compound 22, which is surrounded by a cable jacket 24. In embodiments, the layer of bedding compound 22 has a thickness of up to 5 mm (e.g., 0.1 mm to 5 mm). The cable jacket 24 includes an interior surface 26 and an exterior surface 28. The interior surface 26 defines a central bore 30 along a longitudinal axis of the optical fiber cable 10. The subunits 12, central strength member 14, tensile yarns 20, and bedding compound 22 (collectively, the cable core 32) are contained within the central bore 30 of the cable jacket 24. As shown in FIG. 1, the cable core 32 may also include one or more water-blocking features. For example, in the embodiment depicted in FIG. 1, the cable core 32 includes two strands of swellable yarn 34. In other embodiments, the water-blocking feature may be incorporated into the tensile yarns 20. For example, in embodiments, the tensile yarns 20 can be dusted with superabsorbent polymer powder or provided with a water-absorbing coating. Further, in embodiments, the subunits 12 may be wrapped with a water-blocking tape. The exterior surface 28 of the cable jacket 24 defines an outermost surface of the optical fiber cable 10. The cable jacket 24 has an average thickness between the interior surface 26 and the exterior surface 28. In embodiments, the thickness is from 0.3 mm to 3.0 mm. In embodiments, the either one or both of the layer of bedding compound 22 or the cable jacket 24 is provided with one or more access features, such as ripcords 36.

In embodiments, the cable jacket 24 comprises at least one of high-density polyethylene (HDPE), medium density polyethylene (MDPE), linear low density polyethylene (LLDPE), a flame retardant non-corrosive material, or a low smoke, zero halogen material, among others. In fabricating the optical fiber cable 10, the cable jacket 24 may be extruded over the cable core 32, which requires the material of the cable jacket 24 to be extruded in a molten state at a relatively high temperature (e.g., over 200° C.). These temperatures do not affect basalt fibers in the tensile yarns 20, but UHMWPE has a melting temperature of about 134° C. Accordingly, tensile yarns 20 made of UHMWPE fibers should be prevented from reaching or remaining at that temperature for an extended period of time. This can be accomplished by providing a thermal insulation barrier between the tensile yarns 20 and the cable jacket 24. In this regard, the previously-mentioned bedding compound 22 provides thermal insulation between the cable jacket 24 and the tensile yarns 20 to prevent the tensile yarns 20 from reaching or remaining at or above their melting temperature for an extended period of time while the cable jacket 24 cools on the cable processing line.

The bedding compound 22 is a layer of a highly-filled polymer material. In particular embodiments, the bedding compound 22 is comprised of 70% to 85% by weight of a mineral-based flame-retardant additive, such as aluminum trihydrate or magnesium hydroxide. In embodiments, a portion of the mineral-based flame-retardant additive may be substituted with calcium carbonate. The polymer binder of the bedding compound 22 is comprised of 10% to 30% by weight of a thermoplastic blend of polyolefin elastomers (e.g., EVA, EBA, EMA, EPR, EPDM rubber, and/or styrene-ethylene/butylene-styrene (SEBS)) or polyolefins (e.g., low density polyethylene (LDPE), linear low density polyethylene (LLDPE, and/or polypropylene (PP)). The bedding compound 22 may also comprise a coupling system, such as a maleic acid anhydride-grafted polyolefin, a vinyl-silane, or an aminosilane, in an amount of 0.5% to 4% by weight. Further, the bedding compound 20 may include thermal stabilizers, antioxidants, and or processing additives in the amount of 0.1% to 1.0% each. In embodiments, the bedding compound 22 has a density of 1.7 g/cm³ or greater.

As can be seen in FIG. 1, the bedding compound 22 forms a continuous layer around the tensile yarns 20. In this regard, not only does the bedding compound 22 provide insulation against the thermal energy from the extruded cable jacket 24, but also the bedding compound 22 enhances the flame retardancy performance of the optical fiber cable 10.

As mentioned above, the optical fiber cables 10 including tensile yarns 20 as disclosed herein evolve combustion gasses having lower conductivity and a similar acidity in solution when compared to conventional cables having aramid tensile yarns. The acidity and conductivity of the gasses evolved from combustion of an optical fiber cable 10 as measured in an aqueous solution are relevant in terms of its burn performance according to EN 50267-2-3 (IEC 60754-2). In particular, EN 50267-2-3 sets forth the test method and procedure for determining the degree of acidity of gases evolved during the combustion of the optical fiber cable based on a weighted average of pH and conductivity of the combustion gasses of the constituent materials as measured in an aqueous solution. Table 1, below, provides an example calculation based on a conventional cable having aramid tensile yarns.

TABLE 1

Acidity Calculation for Combustion Gasses of a Cable having Aramid Yarns

| Constituent | Material | kg/km | pH value | Conductivity (µS/mm) | pH Weighted Value | Conductivity Weighted Value |
|---|---|---|---|---|---|---|
| Optical Fiber | Glass | 0.16 | 6.0 | 0.8 | 1.6 × 10⁻⁷ | 0.1 |
| Tensile Yarns | Aramid | 0.50 | 6.6 | 17.4 | 1.3 × 10⁻⁷ | 8.8 |
| Cable Jacket | FRNC | 2.39 | 5.1 | 0.6 | 1.9 × 10⁻⁵ | 1.4 |
| | Total: | 3.05 | | | 1.9 × 10⁻⁵ | 10.3 |

The acronym “FRNC” in Table 1 refers to a flame retardant, non-corrosive jacket material. The cable included three aramid yarns (1680 dtex). From the data in the table, the pH weighted value for the cable is about 5.2 (-log(1.9 × 10⁻⁵/3.05)), and the conductivity weighted value is about 3.38 µS/mm (10.3/3.05), which is higher than allowed for an a1 rating.

As shown in Tables 2 and 3, below, using UHMWPE or basalt yarns does not increase the pH weighted value, but the conductivity weighted value is substantially decreased. In particular, both the cables having the UHMWPE and basalt tensile yarns maintained the pH weighted value of about 5.2, but both cables also exhibited a conductivity weighted value of about 0.5 µS/mm. The cable in Table 2 included three UHMWPE yarns, and the cable in Table 3 included six basalt yarns.

TABLE 2

Acidity Calculation for Combustion Gasses of a Cable having UHMWPE Yarns

| Constituent | Material | Kg/km | pH value | Conductivity (µS/mm) | pH Weighted Value | Conductivity Weighted Value |
|---|---|---|---|---|---|---|
| Optical Fiber | Glass | 0.16 | 6.0 | 0.8 | 1.6 × 10⁻⁷ | 0.1 |
| Tensile Yarns | UHMWPE | 1.08 | 5.2 | 0.34 | 6.8 × 10⁻⁶ | 0.4 |
| Cable Jacket | FRNC | 2.39 | 5.1 | 0.6 | 1.9 × 10⁻⁵ | 1.4 |
| | Total: | 3.63 | | | 1.9 × 10⁻⁵ | 1.9 |

TABLE 3

Acidity Calculation for Combustion Gasses of a Cable having Basalt Yarns

| Constituent | Material | Kg/km | pH value | Conductivity (µS/mm) | pH Weighted Value | Conductivity Weighted Value |
|---|---|---|---|---|---|---|
| Optical Fiber | Glass | 0.16 | 6.0 | 0.8 | 1.6 × 10⁻⁷ | 0.1 |
| Tensile Yarns | Basalt | 0.90 | 5.7 | 0.2 | 1.8 × 10⁻⁶ | 0.2 |
| Cable Jacket | FRNC | 2.39 | 5.1 | 0.6 | 1.9 × 10⁻⁵ | 1.4 |
| | Total: | 3.63 | | | 1.9 × 10⁻⁵ | 1.7 |

According to EN 50267-2-3, a cable can be rated a1, a2, or a3. A cable with an a1 rating produces combustion gasses having a conductivity in aqueous solution of less than 2.5 µS/mm and a pH of greater than 4.3. A cable with an a2 rating produces combustion gasses having a conductivity in aqueous solution of less than 10 µS/mm and a pH of greater than 4.3, and a cable with an a3 rating is unable to meet the requirements of a1 or a2. Here, the cable having the aramid tensile yarns is only able to achieve an a2 rating, whereas both of the cables having the UHMWPE and basalt tensile yarns are able to achieve the more stringent a1 rating.

Advantageously, the enhanced acidity properties do not come at the expense of the mechanical and thermal properties of the tensile yarns. Table 4, below, lists mechanical properties of the UHMWPE and basalt fiber yarns in comparison to conventional aramid yarns. UHMWPE fibers have generally a higher tensile modulus, a higher tensile strength, and a higher elongation at break than aramid fibers. The mechanical properties of basalt fibers substantially overlap with those of aramid fibers in terms of tensile modulus, tensile strength, and elongation at break.

TABLE 4

Mechanical properties of Tensile Yarns by Material

| Material | UHMWPE | Basalt | Aramid |
|---|---|---|---|
| Tensile Modulus | | | |
| GPa | 109-132 | 85-100 | 70.5-112.4 |
| g/den | 1267-1552 | | 555-885 |
| N/tex | 112-137 | | 49-78.1 |
| Tensile Strength | | | |
| GPa | 3.3-3.9 | 1.8-3.1 | 2.92-3.0 |
| g/den | 38-45 | | 23 |
| N/tex | 3.4-4.0 | | 2.03-2.08 |
| Elongation at Break (%) | 3-4 | 2.5-3.5 | 2.4-3.6 |

With respect to thermal properties, basalt fibers have a significantly greater operational temperature range than aramid fibers. Basalt fibers can be used continuously at temperatures up to 460° C. and can operate for short durations at temperatures up to 1000° C. Aramid fibers, by comparison, have a continuous operation range of about 150° C. to 170° C. and a maximum short term operational temperature of up to about 200° C.

In order to enhance the mechanical properties of basalt yarns, the basalt yarns, in embodiments, are incorporated into composite yarns with at least one other non-aramid yarn. Example yarns for the composite strand are comprised of at least one of UHMWPE, glass fiber, liquid crystal polymer (LCP), low shrink polyester, or carbon fiber. In embodiments, the composite yarns are in the form of at least one of interplay hybrids, intermingled hybrids, selective placement hybrids, and super-hybrid composites. Table 5, below, provides a list of the mechanical properties of certain materials that can be used to form a composite yarn with basalt.

TABLE 5

Mechanical and Thermal Properties of Fibers for Basalt Composite Yarns

| Material | Glass Fiber | LCP | Carbon Fiber |
|---|---|---|---|
| Tensile Modulus | | | |
| GPa | 70-75 | 75-100 | 230-600 |
| Tensile Strength | | | |
| GPa | 2.2-2.4 | 3.0-3.2 | 3.3-3.5 |
| g/den | 6-9 | 23-30 | 23-50 |
| Elongation at Break (%) | 3.5-5.5 | 2.8-3.8 | 3.3-3.5 |
| Max. Service Temp. (°C) | 380 | 150 | 500 |
| Conductivity (µS/mm) | 0.14 | 1.3 | -- |
| pH | 6.0 | 5.0 | -- |

As mentioned above, basalt yarns 20 are not expected to experience any issues during normal processing as a result of cable jacket extrusion. However, as discussed above, the UHMWPE fibers have a melting point below the temperature at which the cable jacket is typically extruded. In order to simulate the effect of processing on the UHMWPE tensile yarns 20, the yarns 20 were tested for the mechanical properties of elongation at break, breaking tenacity (tensile strength), and tensile modulus before and after annealing treatments. The measured property referenced in the following discussion represents the average value for the specimens tested.

The elongation at break before annealing was about 3.75%. After annealing at 60° C. for fifteen minutes, the elongation at break was still about 3.7%. When subjected to an annealing treatment at 120° C. for fifteen minutes, elongation at break only decreased to 3.5%. Thus, when exposed to an annealing treatment to simulate processing conditions, the UHMWPE yarns did not exhibit a substantial decrease in elongation at break.

The breaking tenacity (tensile strength) was tested in a similar manner with samples being tested before an annealing treatment and after two separate annealing treatments. Prior to annealing, the UHMWPE yarns exhibited a breaking tenacity of about 2950 mN/tex. After annealing at 60° C. for fifteen minutes, the breaking tenacity increased to about 3150 mN/tex, and after annealing at 120° C. for fifteen minutes, the breaking tenacity was about 3000 mN/tex. Thus, the temperatures associated with processing of the UHMWPE yarns tend to increase the mechanical property of breaking tenacity.

The tensile modulus was also tested in the before and after annealing conditions. Prior to annealing, the UHMWPE yarns exhibited a tensile modulus of about 95 N/tex. After annealing at 60° C. for fifteen minutes, the tensile modulus of the UHMWPE yarns increased to about 100 N/tex, and after annealing at 120° C. for fifteen minutes, the tensile modulus only decreased to about 99 N/tex, which was more than the initial, unannealed tensile modulus.

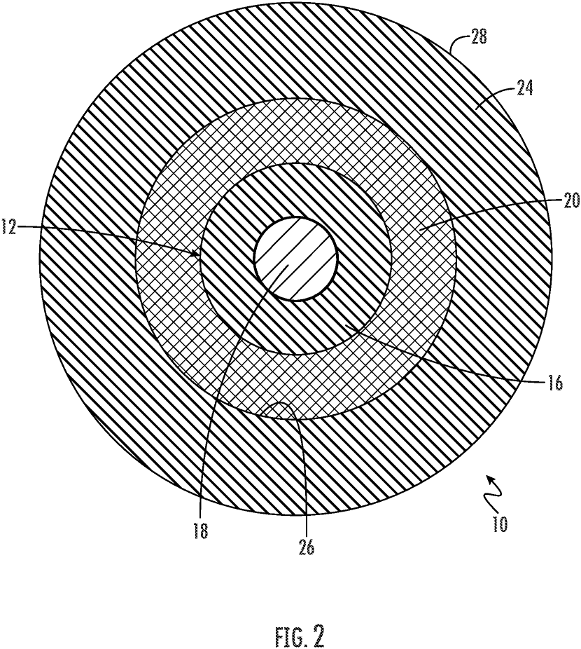

Having demonstrated through simulated processing that the properties of the UHMWPE yarns can be maintained at the temperatures associated with cable jacket extrusion, the UHMWPE yarns were incorporated into an optical fiber cable. The optical fiber cable 10 constructed using the UHMWPE yarns is shown in FIG. 2. The optical fiber cable 10 includes a single subunit 12 having a single optical fiber 18 disposed within a tight buffer tube 16. The tight-buffered subunit 12 was surrounded by three UHMWPE yarns as the tensile yarns 20. The cable jacket 24 was extruded around the tensile yarns 20. The optical fiber cable 10 of this construction is known as Simplex 2.0. The cable jacket was extruded at a processing temperature above the melting temperature of the UHMWPE yarns. During production of the optical fiber cable 10 using the UHMWPE yarns as tensile yarns 20, no problems, such as dusting or tangling, were encountered.

In order to confirm that the mechanical properties of the UHMWPE yarns were not substantially diminished as a result of the processing conditions, the UHMWPE yarns were removed from the optical fiber cable 10 and tested to determine the properties of elongation at break, breaking tenacity (tensile strength), and tensile modulus according to the same procedure described above with respect to the specimens tested before and after the annealing treatments. The elongation at break for the UHMWPE yarns removed from the cable 10 was about 4.3%. The breaking tenacity was about 2700 mN/tex, and the tensile modulus was about 70 N/tex. Thus, after processing, the UHMWPE yarns exhibited an elongation at break in line with what was predicted from the simulations. The breaking tenacity and tensile modulus were lower than what was predicted from the simulation, but the measured values were still within an acceptable range to act as tensile yarns 20.

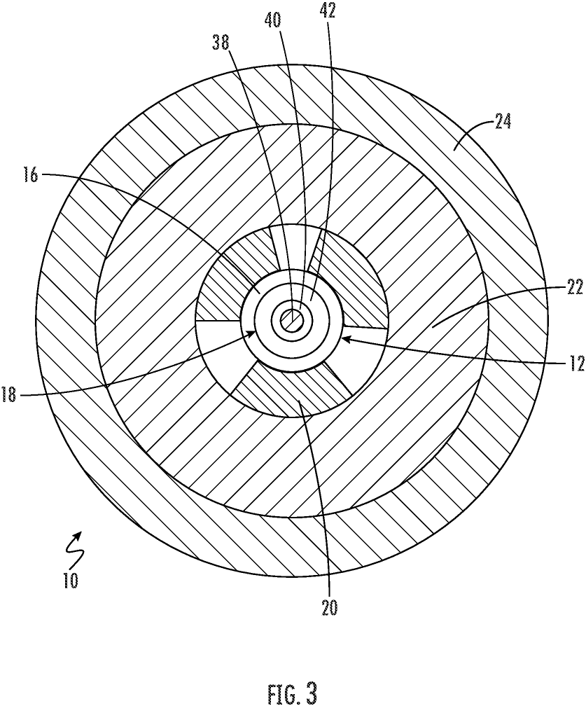

The UHMWPE tensile yarns 20 and/or basalt tensile yarns 20 can be incorporated into a variety of other optical fiber cable 10 constructions as shown in FIGS. 3-8.

Referring first to FIG. 3, the embodiment of the optical fiber cable 10 is similar to the embodiment of FIG. 2, but the embodiment shown in FIG. 3 includes a layer of the bedding compound 22 disposed between the tensile yarns 20 and the cable jacket 24. That is, the optical fiber cable 10 includes a single subunit 12 having a single optical fiber 18 disposed within a tight buffer tube 16. For the sake of clarity, the tight buffered optical fiber subunit 12 depicted in FIG. 3 includes a core 38 configured to carry optical signals, a cladding layer 40 configured to trap the optical signals in the core 38, and a protective coating layer 42. Three tensile yarns 20 are provided around the subunit 12. The layer of bedding compound 22 is extruded around the tensile yarns 20, and the cable jacket 24 is extruded around the bedding compound 22.

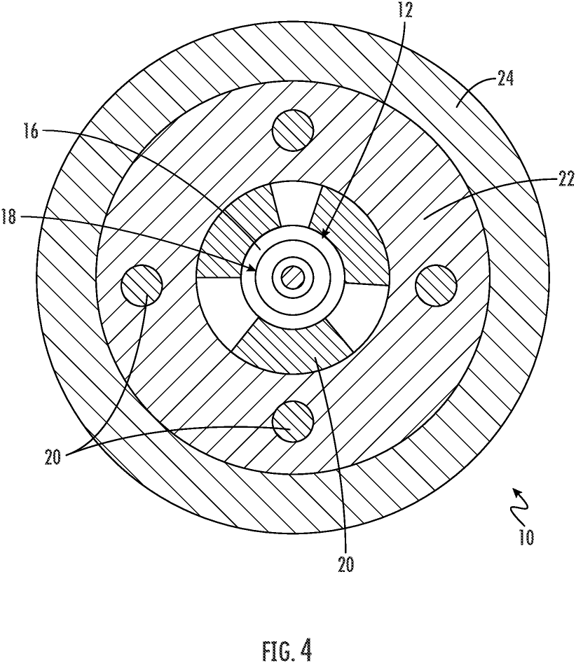

The embodiment depicted in FIG. 4 is substantially similar to the embodiment shown in FIG. 3. However, in the embodiment shown in FIG. 4, the tensile yarns 20 may be embedded in the bedding compound 22 instead of or in addition to the tensile yarns 20 wrapped around the subunit 12. As with the previous embodiment, the optical fiber cable 10 includes a single subunit 12 having a single optical fiber 18 (e.g., having the construction shown in FIG. 3) disposed within a tight buffer tube 16. Also like the previous embodiment, the optical fiber cable 10 depicted includes three tensile yarns 20 extending along the length of the subunit 12.

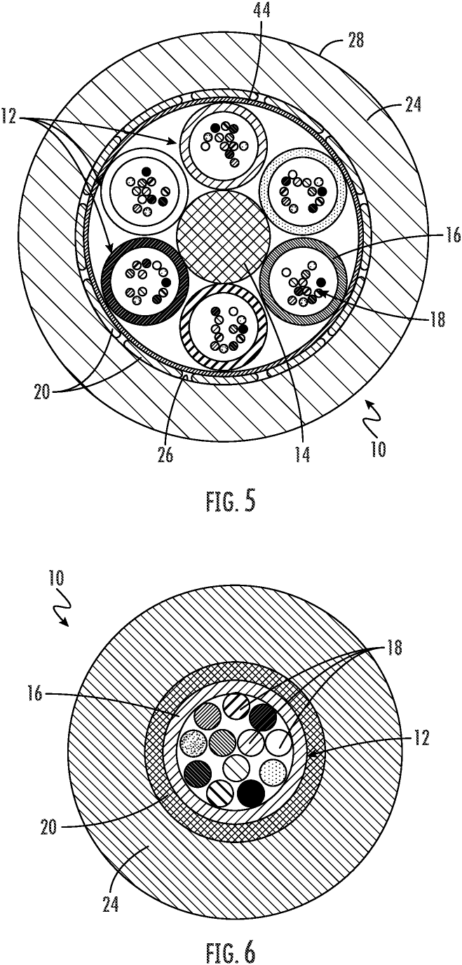

The embodiment depicted in FIG. 5 is substantially similar to the embodiment shown in FIG. 1 with the exceptions that the embodiment shown in FIG. 5 does not include a layer of bedding compound 22 and does include a layer of water-blocking tape 44.

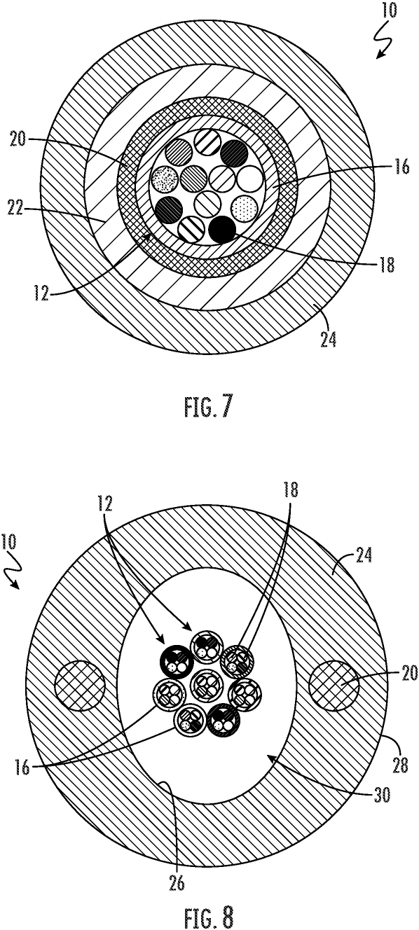

The embodiments depicted in FIGS. 6 and 7 are similar to the embodiments depicted in FIGS. 2 and 3. In particular, FIG. 6, like FIG. 2, depicts a single subunit 12 having a plurality of tensile yarns 20 positioned around the single subunit 12. The plurality of tensile yarns 20 are directly surrounded by the cable jacket 24. The primary distinction between the embodiment of FIG. 6 and the embodiment of FIG. 2 is that, in FIG. 6, the subunit 14 includes a plurality of optical fibers 18 in the buffer tube 16 in a loose tube configuration. FIG. 7 includes the additional element of a layer of bedding compound 22 disposed between the plurality of tensile yarns 20 and the cable jacket 24.

FIG. 8 depicts still another embodiment of an optical fiber cable 10 in which the tensile yarns 20 are embedded in the cable jacket 24. As can be seen in FIG. 8, the central bore 30 of the cable jacket 24 includes multiple subunits 12. Each subunit 12 includes a buffer tube 16 in which a plurality of optical fibers 18 are disposed.

In each of these embodiments, the tensile yarns 20 includes at least one UHMWPE yarns or basalt yarns, and the tensile yarns 20 do not include aramid yarns. In particular, the embodiments without a layer of bedding compound 22 (e.g., as shown in FIGS. 2, 5, 6, and 8) are particularly suited for basalt yarns in view of the high temperature stability of such basalt yarns. Advantageously, such UHMWPE and basalt tensile yarns 20 are relatively less expensive than aramid yarns, and there is very little or no reduction in the thermal and mechanical properties of the newly disclosed tensile yarns 20 as compared to the conventional aramid yarns. Further, the presently disclosed optical fiber cable constructions in which the UHMWPE or basalt tensile yarns 20 are employed are able to achieve an a1 rating when tested according to EN 50267-2-3 on account of the lower conductivity of combustion gasses in aqueous solution evolved from the tensile yarns 20 as compared to aramid yarns.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
a cable jacket comprising an interior surface and an exterior surface, the interior surface defining a central bore extending along a longitudinal axis of the optical fiber cable and the exterior surface defining an outermost surface of the optical fiber cable;
at least one subunit disposed within the central bore, each of the at least one subunit comprising at least one optical fiber disposed within a buffer tube;
a plurality of ultrahigh molecular weight polyethylene (UHMWPE) tensile yarns positioned around the at least one subunit and extending along the longitudinal axis; and
a layer of a bedding compound disposed between the plurality of UHMWPE tensile yarns and the cable jacket.

2. The optical fiber cable of claim 1, wherein the optical fiber cable achieves an a1 rating when tested according to EN 50267-2-3.

3. The optical fiber cable of claim 1, wherein the bedding compound comprises 10 wt% -30 wt% of a polymeric binder and 70 wt% - 85 wt% of a flame-retardant additive.

4. The optical fiber cable of claim 1, wherein the plurality of UHMWPE tensile yarns comprises at least one yarn embedded in the bedding compound.

5. The optical fiber cable of claim 1, wherein gasses evolved from combustion of the plurality of UHMWPE tensile yarns comprises a conductivity of 0.50 µS/mm of less as measured in an aqueous solution according to EN 50267-2-3.

6. The optical fiber cable of claim 1, wherein the optical fiber cable does not comprise aramid yarns.

7. An optical fiber cable, comprising:
a cable jacket comprising an interior surface and an exterior surface, the interior surface defining a central bore extending along a longitudinal axis of the optical fiber cable and the exterior surface defining an outermost surface of the optical fiber cable;
at least one subunit disposed within the central bore, each of the at least one subunit comprising at least one optical fiber disposed within a buffer tube; and
a plurality of tensile yarns disposed within the central bore and around the at least one subunit and extending along the longitudinal axis;
wherein the plurality of tensile yarns comprises basalt yarns.

8. The optical fiber cable of claim 7, wherein the plurality of tensile yarns further comprises yarns of at least one other material.

9. The optical fiber cable of claim 8, wherein the yarns of at least one other material comprises at least one of UHMWPE yarns, glass fiber yarns, liquid crystal polymer yarns, low shrink polyester yarns, or carbon fiber yarns.

10. The optical fiber cable of claim 7, wherein the optical fiber cable achieves an a1 rating when tested according to EN 50267-2-3.

11. The optical fiber cable of claim 7, wherein the plurality of tensile yarns does not comprise aramid yarns.

12. A method of manufacturing an optical fiber cable, the method comprising:
arranging a plurality of tensile yarns around at least one subunit, each of the at least one subunit comprising at least one optical fiber disposed within a buffer tube, wherein the plurality of tensile yarns comprise at least one of ultra-high molecular weight polyethylene (UHMWPE) yarns or basalt yarns;
extruding a cable jacket around the plurality of tensile yarns, the cable jacket comprising an interior surface and an exterior surface, wherein the exterior surface is an outermost surface of the optical fiber cable and wherein the interior surface is arranged facing the plurality of tensile yarns.

13. The method of claim 12, wherein the plurality of tensile yarns are UHMWPE yarns.

14. The method of claim 13, further comprising forming a layer of a bedding compound around the at least one subunit prior to extruding the cable jacket.

15. The method of claim 14, wherein forming the layer of the bedding compound further comprises forming the layer around the plurality of tensile yarns such that the layer is disposed between the interior surface of the cable jacket and the plurality of tensile yarns.

16. The method of claim 14, wherein forming the layer of the bedding compound further comprises embedding the plurality of tensile yarns in the layer of the bedding compound.

17. The method of claim 12, wherein the plurality of tensile yarns comprise the basalt yarns and yarns of at least one other material.

18. The method of claim 17, wherein the yarns of at least one other material comprise yarns of at least one of UHMWPE, glass fiber, liquid crystal polymer, low shrink polyester, or carbon fiber.
